(19) United States
(12) Patent Application Publication
(10) Pub. No.: US 2025/0185020 A1
(43) Pub. Date: Jun. 5, 2025

(54) MULTIPLE CODEWORDS ENHANCEMENT FOR SINGLE TRANSPORT BLOCK AND MULTIPLE TRANSPORT BLOCK TRANSMISSIONS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/840,445

(22) PCT Filed: Apr. 29, 2022
(86) PCT No.: PCT/CN2022/090179

§ 371 Date: Aug. 21, 2024

(51) Int. Cl. H04W 72/232; H04W 72/1268

(52) U.S. Cl. CPC H04W 72/232; H04W 72/1268

(57) ABSTRACT

Various aspects of the present disclosure generally relate to wireless communication. In some aspects, a user equipment (UE) may receive downlink control information (DCI) that schedules a physical uplink shared channel (PUSCH). The DCI includes a code block group transmission information field that includes a quantity of bits based on a quantity of codewords configured for the UE. Accordingly, the UE may transmit on the PUSCH according to the DCI. Numerous other aspects are described.

### FIELD OF THE DISCLOSURE

Aspects of the present disclosure generally relate to wireless communication and to techniques and apparatuses for multiple codewords enhancement for single transport block and multiple transport block transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some implementations described herein relate to a method of wireless communication performed by a user equipment (UE). The method may include receiving downlink control information (DCI) that schedules a physical uplink shared channel (PUSCH), wherein the DCI includes a code block group (CBG) transmission information (CBGTI) field that includes a quantity of bits based on a quantity of codewords configured for the UE. The method may include transmitting on the PUSCH according to the DCI.

Some implementations described herein relate to an apparatus for wireless communication at a UE. The apparatus may include a memory and one or more processors coupled to the memory. The one or more processors may be configured to receive DCI that schedules a PUSCH, wherein the DCI includes a CBGTI field that includes a quantity of bits based on a quantity of codewords configured for the UE. The one or more processors may be further configured to transmit on the PUSCH according to the DCI.

Some aspects described herein relate to a non-transitory computer-readable medium that stores a set of instructions for wireless communication by a UE. The one or more instructions, when executed by one or more processors of the UE, may cause the UE to receive DCI that schedules a PUSCH, wherein the DCI includes a CBGTI field that includes a quantity of bits based on a quantity of codewords configured for the UE. The one or more instructions, when executed by one or more processors of the UE, may further cause the UE to transmit on the PUSCH according to the DCI.

Some aspects described herein relate to an apparatus for wireless communication. The apparatus may include means for receiving DCI that schedules a PUSCH, wherein the DCI includes a CBGTI field that includes a quantity of bits based on a quantity of codewords configured for the apparatus. The apparatus may further include means for transmitting on the PUSCH according to the DCI.

Some implementations described herein relate to a method of wireless communication performed by a network entity. The method may include transmitting DCI that schedules a PUSCH, wherein the DCI includes a CBGTI field that includes a quantity of bits based on a quantity of codewords configured for a UE. The method may include receiving on the PUSCH according to the DCI.

Some implementations described herein relate to an apparatus for wireless communication at a network entity. The apparatus may include a memory and one or more processors coupled to the memory. The one or more processors may be configured to transmit DCI that schedules a PUSCH, wherein the DCI includes a CBGTI field that includes a quantity of bits based on a quantity of codewords configured for a UE. The one or more processors may be further configured to receive on the PUSCH according to the DCI.

Some aspects described herein relate to a non-transitory computer-readable medium that stores a set of instructions for wireless communication by a network entity. The one or more instructions, when executed by one or more processors of the network entity, may cause the network entity to transmit DCI that schedules a PUSCH, wherein the DCI includes a CBGTI field that includes a quantity of bits based on a quantity of codewords configured for a UE. The one or more instructions, when executed by one or more processors of the network entity, may further cause the network entity to receive on the PUSCH according to the DCI.

Some aspects described herein relate to an apparatus for wireless communication. The apparatus may include means for transmitting DCI that schedules a PUSCH, wherein the DCI includes a CBGTI field that includes a quantity of bits based on a quantity of codewords configured for a UE. The apparatus may further include means for receiving on the PUSCH according to the DCI.

Some implementations described herein relate to a method of wireless communication performed by a UE. The method may include receiving a control message indicating two codewords transmission are enabled. The method may include receiving DCI that schedules a plurality of PUSCHs, wherein the DCI indicates a first MCS for a first codeword of the plurality of PUSCHs and a second MCS for a second codeword of the plurality of PUSCHs. The method may include transmitting on the plurality of PUSCHs according to the DCI.

Some implementations described herein relate to an apparatus for wireless communication at a UE. The apparatus may include a memory and one or more processors coupled to the memory. The one or more processors may be configured to receive a control message indicating two codewords transmission are enabled. The one or more processors may be configured to receive DCI that schedules a plurality of PUSCHs, wherein the DCI indicates a first MCS for a first codeword of the plurality of PUSCHs and a second MCS for a second codeword of the plurality of PUSCHs. The one or more processors may be further configured to transmit on the plurality of PUSCHs according to the DCI.

Some aspects described herein relate to a non-transitory computer-readable medium that stores a set of instructions for wireless communication by a UE. The one or more instructions, when executed by one or more processors of the UE, may cause the UE to receive a control message indicating two codewords transmission are enabled. The one or more instructions, when executed by one or more processors of the UE, may cause the UE to receive DCI that schedules a plurality of PUSCHs, wherein the DCI indicates a first MCS for a first codeword of the plurality of PUSCHs and a second MCS for a second codeword of the plurality of PUSCHs. The one or more instructions, when executed by one or more processors of the UE, may further cause the UE to transmit on the plurality of PUSCHs according to the DCI

Some aspects described herein relate to an apparatus for wireless communication. The apparatus may include means for receiving a control message indicating two codewords transmission are enabled. The apparatus may include means for receiving DCI that schedules a plurality of PUSCHs, wherein the DCI indicates a first MCS for a first codeword of the plurality of PUSCHs and a second MCS for a second codeword of the plurality of PUSCHs. The apparatus may further include means for transmitting on the plurality of PUSCHs according to the DCI.

Some implementations described herein relate to a method of wireless communication performed by a network entity. The method may include transmitting a control message indicating two codewords transmission are enabled for a UE. The method may include transmitting DCI that schedules a plurality of PUSCHs, wherein the DCI indicates a first MCS for a first codeword of the plurality of PUSCHs and a second MCS for a second codeword of the plurality of PUSCHs. The method may include receiving on the plurality of PUSCHs according to the DCI.

Some implementations described herein relate to an apparatus for wireless communication at a network entity. The apparatus may include a memory and one or more processors coupled to the memory. The one or more processors may be configured to transmit a control message indicating two codewords transmission are enabled for a UE. The one or more processors may be configured to transmit DCI that schedules a plurality of PUSCHs, wherein the DCI indicates a first MCS for a first codeword of the plurality of PUSCHs and a second MCS for a second codeword of the plurality of PUSCHs. The one or more processors may be further configured to receive on the plurality of PUSCHs according to the DCI.

Some aspects described herein relate to a non-transitory computer-readable medium that stores a set of instructions for wireless communication by a network entity. The one or more instructions, when executed by one or more processors of the network entity, may cause the network entity to transmit a control message indicating two codewords transmission are enabled for a UE. The one or more instructions, when executed by one or more processors of the network entity, may cause the network entity to transmit DCI that schedules a plurality of PUSCHs, wherein the DCI indicates a first MCS for a first codeword of the plurality of PUSCHs and a second MCS for a second codeword of the plurality of PUSCHs. The one or more instructions, when executed by one or more processors of the network entity, may further cause the network entity to receive on the plurality of PUSCHs according to the DCI.

Some aspects described herein relate to an apparatus for wireless communication. The apparatus may include means for transmitting a control message indicating two codewords transmission are enabled for a UE. The apparatus may include means for transmitting DCI that schedules a plurality of PUSCHs, wherein the DCI indicates a first MCS for a first codeword of the plurality of PUSCHs and a second MCS for a second codeword of the plurality of PUSCHs. The apparatus may further include means for receiving on the plurality of PUSCHs according to the DCI.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of code block groups (CBGs), in accordance with the present disclosure.

FIG. 5 is a diagram illustrating an example of scheduling multiple physical uplink shared channel (PUSCH) transmissions, in accordance with the present disclosure.

FIG. 6 is a diagram illustrating an example associated with transmitting and using downlink control information (DCI) for CBG transmission, in accordance with the present disclosure.

FIGS. 7A, 7B, and 7C are diagrams illustrating examples associated with mapping DCI bits to CBGs, in accordance with the present disclosure.

FIG. 8 is a diagram illustrating an example associated with DCI fields for multiple PUSCH transmissions, in accordance with the present disclosure.

FIGS. 9, 10, 11, and 12 are diagrams illustrating example processes associated with transmitting and using DCI for CBG transmission, in accordance with the present disclosure.

FIGS. 13 and 14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

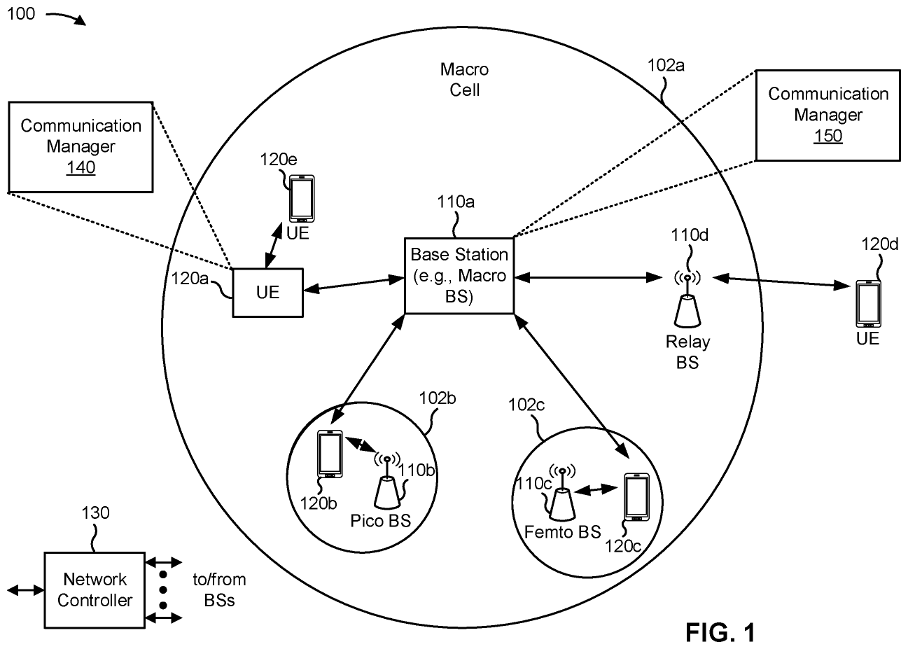

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

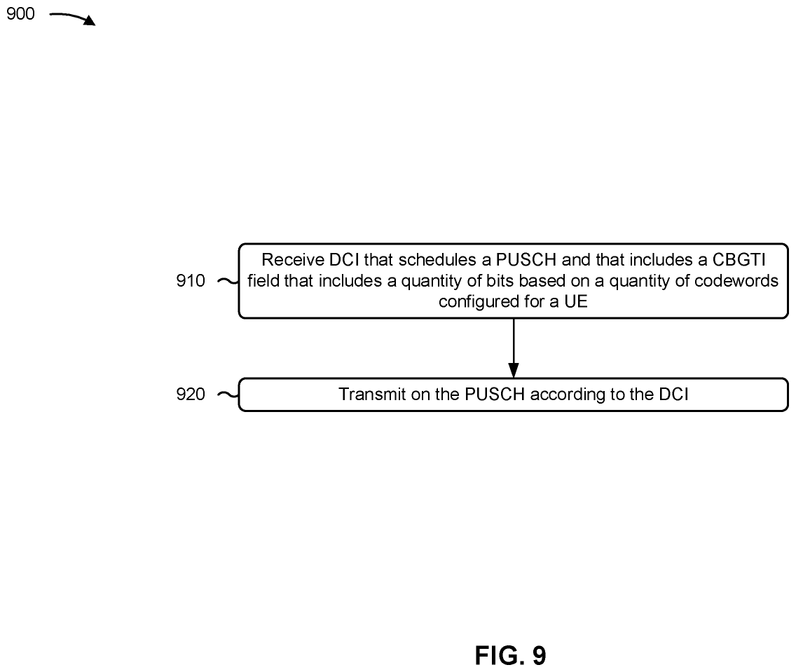

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive downlink control information (DCI) that schedules a physical uplink shared channel (PUSCH), wherein the DCI includes a code block group (CBG) transmission information (CBGTI) field that includes a quantity of bits based on a quantity of codewords configured for the UE 120; and transmit on the PUSCH according to the DCI. Additionally, or alternatively, as described in more detail elsewhere herein, the communication manager 140 may receive a control message indicating two codewords transmission are enabled; receive DCI that schedules a plurality of PUSCHs, wherein the DCI indicates a first modulation and coding scheme (MCS) for a first codeword of the plurality of PUSCHs and a second MCS for a second codeword of the plurality of PUSCHs; and transmit on the plurality of PUSCHs according to the DCI. Additionally, or alternatively, the communication manager 140 may perform one or more other operations described herein.

In some aspects, a network entity (e.g., the base station 110) may include a communication manager 150. As described in more detail elsewhere herein, the communication manager 150 may transmit DCI that schedules a PUSCH, wherein the DCI includes a CBGTI field that is associated with a maximum quantity of bits based on a quantity of codewords configured for the UE 120; and receive on the PUSCH according to the DCI. Additionally, or alternatively, as described in more detail elsewhere herein, the communication manager 150 may transmit a control message indicating two codewords transmission are enabled for the UE 120; transmit DCI that schedules a plurality of PUSCHs, wherein the DCI indicates a first MCS for a first codeword of the plurality of PUSCHs and a second MCS for a second codeword of the plurality of PUSCHs; and receive on the plurality of PUSCHs according to the DCI. Additionally, or alternatively, the communication manager 150 may perform one or more other operations described herein.

As indicated above, FIG. 1 is provided as an example. Other examples may differ from what is described with regard to FIG. 1.

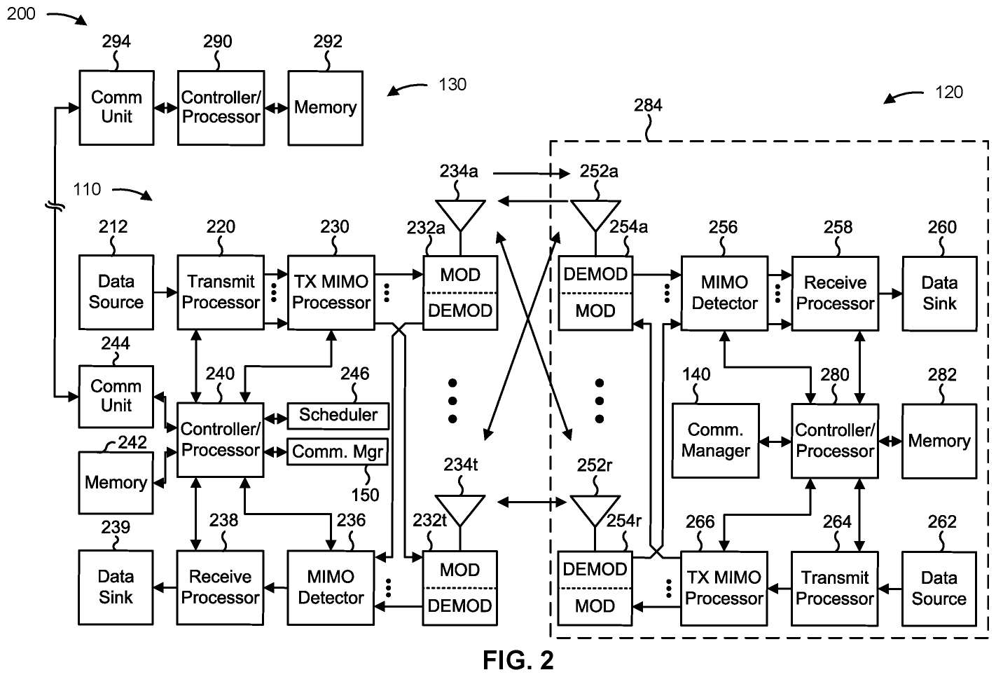

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

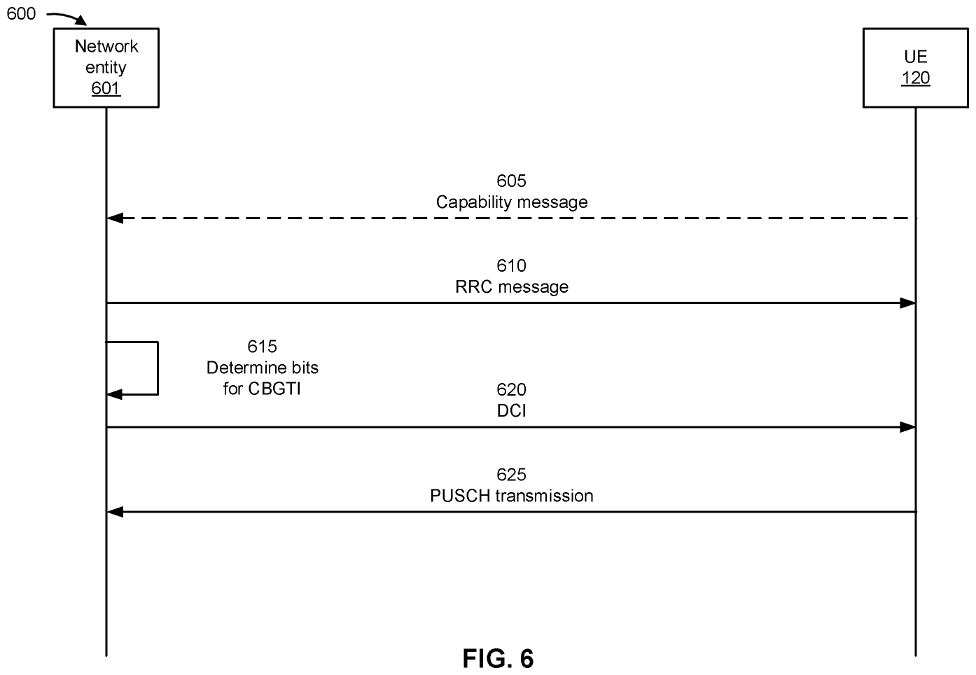

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-14).

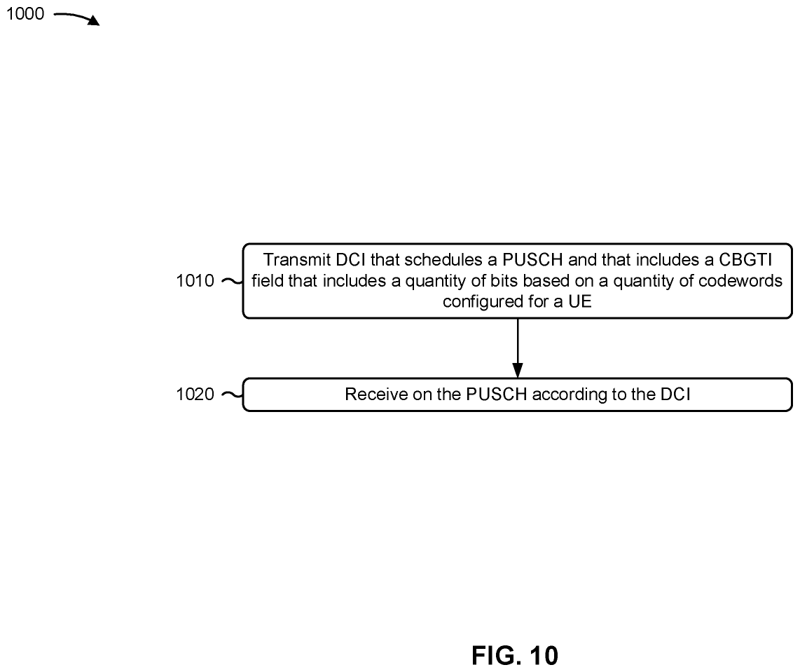

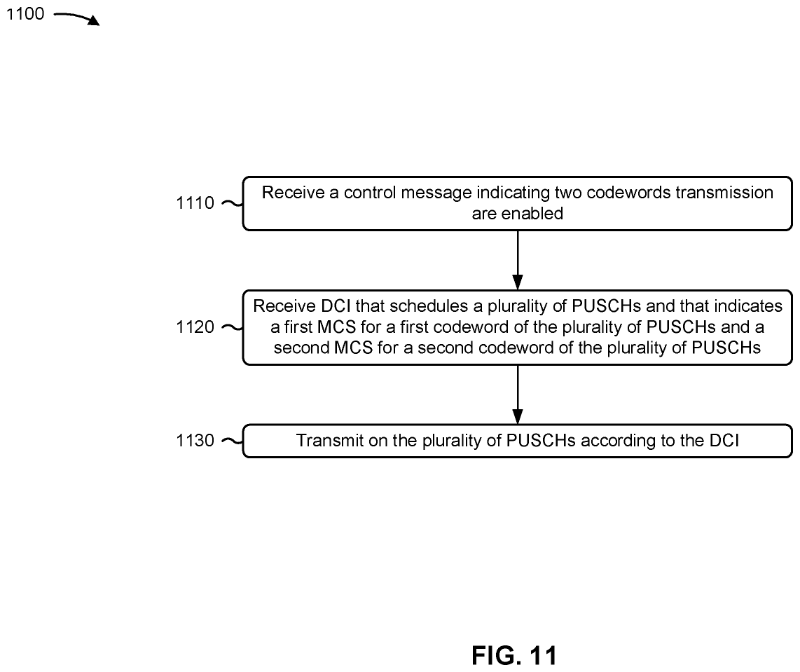

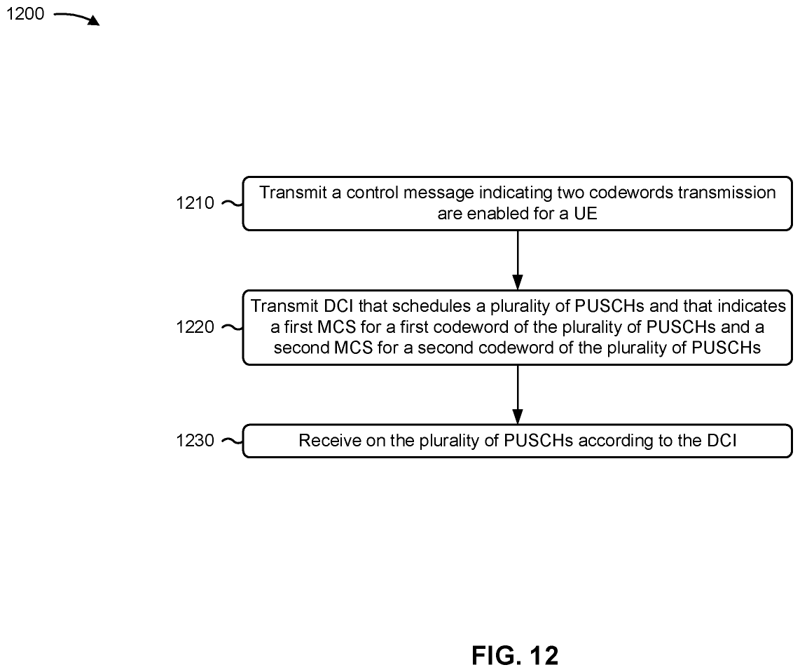

The controller/processor 240 of the base station 110, the controller/processor 280 of the UE 120, and/or any other component(s) of FIG. 2 may perform one or more techniques associated with transmitting and using downlink control information for code block group transmission, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

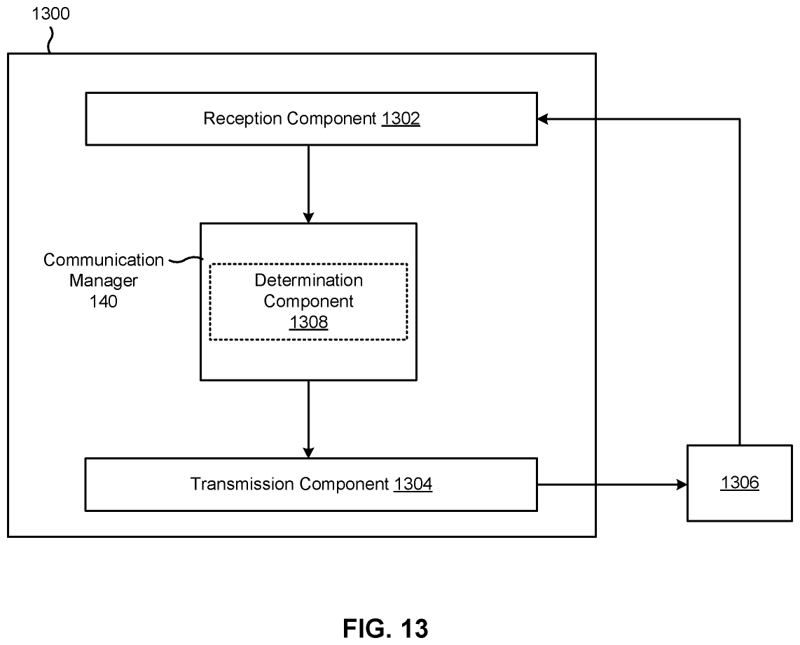

In some aspects, a UE (e.g., UE 120 and/or apparatus 1300 of FIG. 13) may include means for receiving DCI that schedules a PUSCH, wherein the DCI includes a CBGTI field that includes a quantity of bits based on a quantity of codewords configured for the UE; and/or means for transmitting on the PUSCH according to the DCI. Additionally, or alternatively, the UE may include means for receiving a control message indicating two codewords transmission are enabled; means for receiving DCI that schedules a plurality of PUSCHs, wherein the DCI indicates a first MCS for a first codeword of the plurality of PUSCHs and a second MCS for a second codeword of the plurality of PUSCHs; and/or means for transmitting on the plurality of PUSCHs according to the DCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

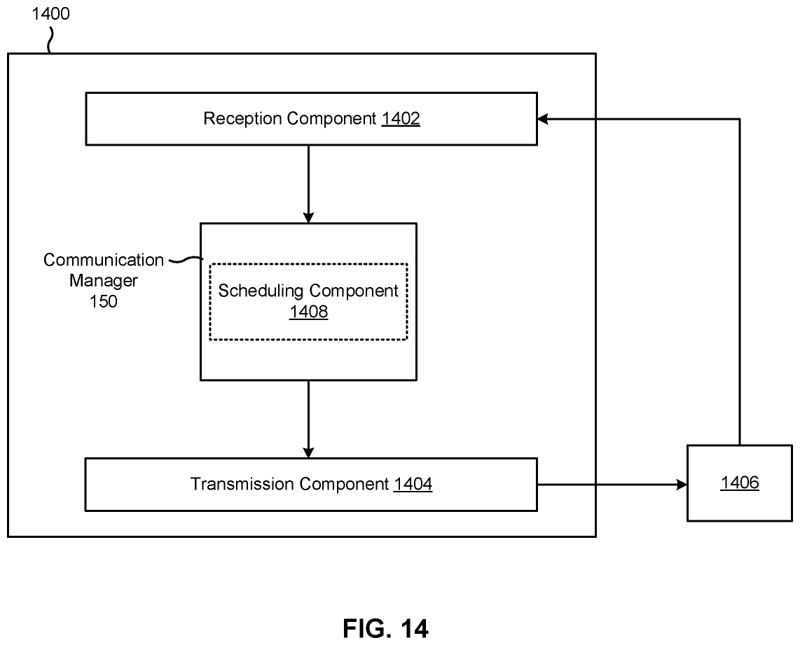

In some aspects, a network entity (e.g., base station 110, CU 310, DU 330, RU 340, and/or apparatus 1400 of FIG. 14) may include means for transmitting DCI that schedules a PUSCH, wherein the DCI includes a CBGTI field that is associated with a maximum quantity of bits based on a quantity of codewords configured for a UE (e.g., UE 120 and/or apparatus 1300 of FIG. 13); and/or means for receiving on the PUSCH according to the DCI. Additionally, or alternatively, the network entity may include means for transmitting a control message indicating two codewords transmission are enabled for the UE; means for transmitting DCI that schedules a plurality of PUSCHs, wherein the DCI indicates a first MCS for a first codeword of the plurality of PUSCHs and a second MCS for a second codeword of the plurality of PUSCHs; and/or means for receiving on the plurality of PUSCHs according to the DCI. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

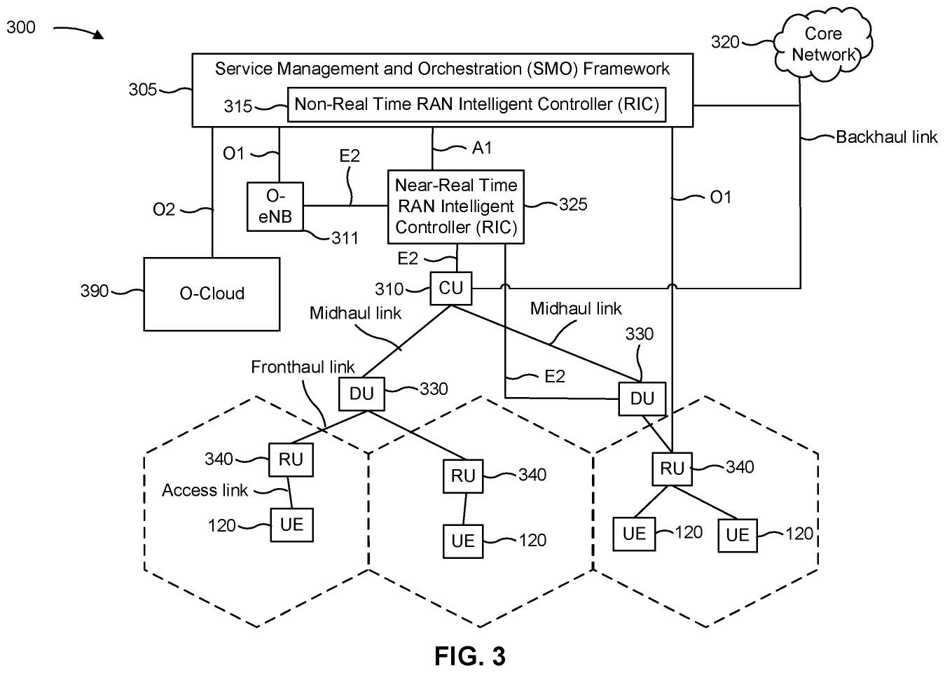

FIG. 3 is a diagram illustrating an example 300 disaggregated base station architecture, in accordance with the present disclosure. Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

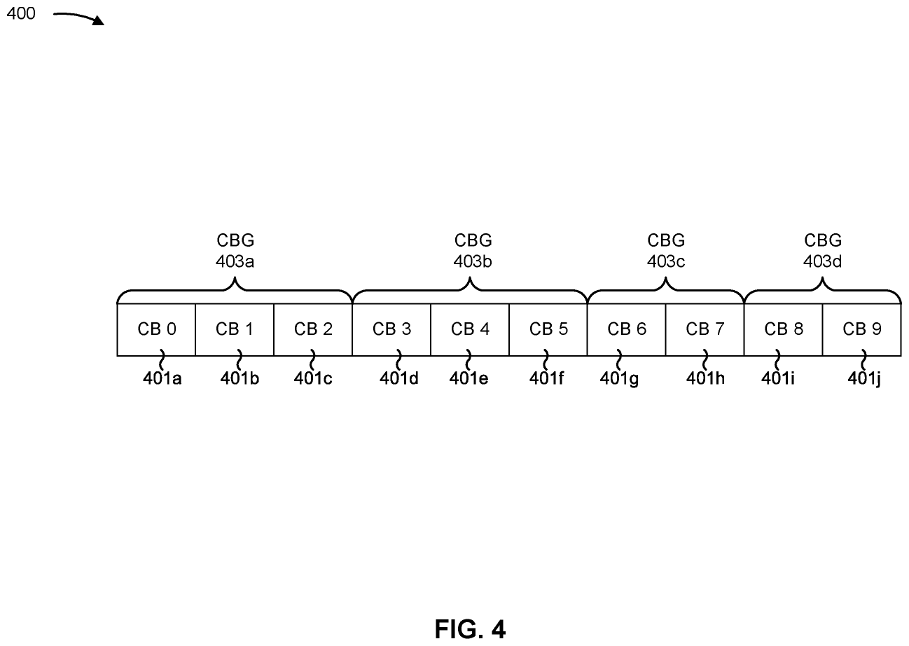

FIG. 4 is a diagram illustrating an example 400 of CBGs, in accordance with the present disclosure. As shown in FIG. 4, example 400 includes a plurality of code blocks (CBs) 401a, 401b, 401c, 401d, 401e, 401f, 401g, 401h, 401i, and 401j. As used herein, a “code block” refers to a group of data (e.g., generated by a UE 120) that is smaller than a transport block (TB). As used herein, a “transport block” refers to a data payload passed from a higher layer (e.g., a MAC layer of the UE 120) to a lower layer (e.g., a PHY layer of the UE 120). Each CB in example 400 is identified using a corresponding index (e.g., 0, 1, 2, 3, 4, 5, 6, 7, 8, and 9 in example 400). Although described using ten CBs, other examples may include fewer CBs (e.g., nine CBs, eight CBs, and so on) or additional CBs (e.g., eleven CBs, twelve CBs, and so on).

By using CBs, a network entity (e.g., an RU 340 and/or a device controlling the RU 340, such as a CU 310 and/or DU 330) may instruct the UE 120 to retransmit individual CBs that were not received rather than an entire TB. Accordingly, the network entity may conserve overhead, power, and processing resources by reducing a size of retransmissions from the UE 120.

As further shown in FIG. 4, one or more CBs may be logically sorted into CBGs. For example, CBs 401a, 401b, and 401c may be grouped into CBG 403a; CBs 401d, 401e, and 401f may be grouped into CBG 403b; CBs 401g and 401h may be grouped into CBG 403c; and CBs 401i and 401j may be grouped into CBG 403d. In some aspects, as shown in FIG. 4, the UE 120 may group the CBs into CBGs sequentially according to corresponding indices. Additionally, or alternatively, the UE 120 may group the CBs into CBGs based on a target size for each CBG and/or a maximum size for each CBG. Accordingly, the UE 120 may apply a packing algorithm to efficiently group the CBs into CBGs based on the target size for each CBG and/or the maximum size for each. In another example, the UE 120 may apply a packing algorithm to efficiently group the CBs into CBGs based on a maximum quantity of CBGs per TB. For example, the network entity may indicate the maximum quantity of CBGs per TB in order to reduce a size of acknowledgement/negative-acknowledgement (ACK/NACK) feedback to be transmitted to the UE 120.

Accordingly, the UE 120 may logically map the CBGs into TBs for transmission (e.g., OTA) to the network entity (e.g., directly or to an RU 340 controlled by the network entity).

As indicated above, FIG. 4 is provided as an example. Other examples may differ from what is described with respect to FIG. 4.

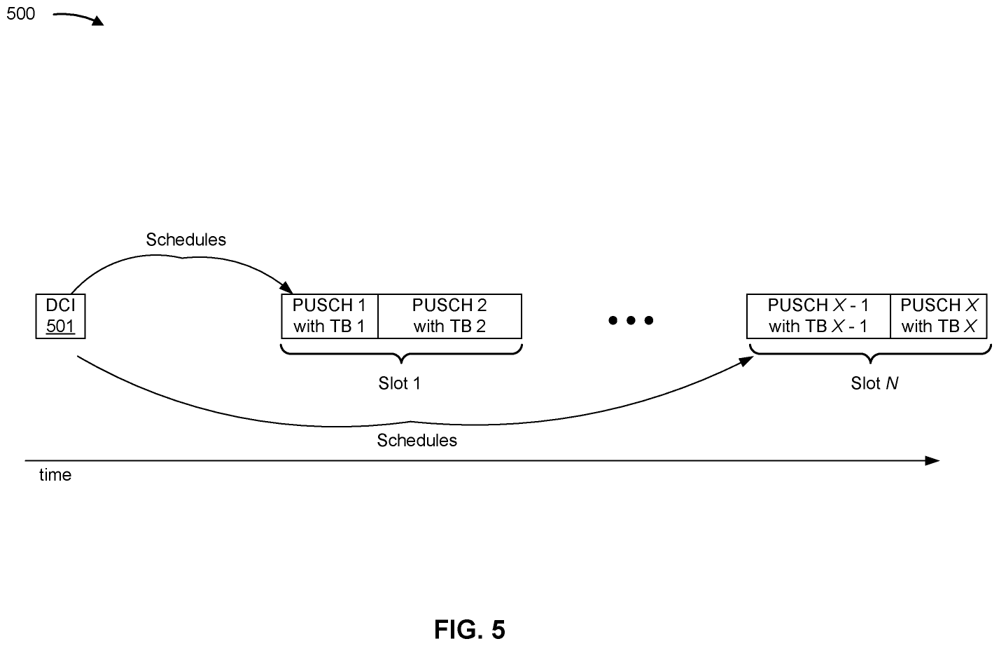

FIG. 5 is a diagram illustrating an example 500 of scheduling multiple PUSCH transmissions, in accordance with the present disclosure. As shown in FIG. 5, a network entity (e.g., an RU 340 and/or a device controlling the RU 340, such as a CU 310 and/or DU 330) may transmit DCI 501 to a UE (e.g., UE 120) to schedule a plurality of PUSCHs. In example 500, the DCI 501 schedules, in an initial slot, one or more PUSCH transmission (e.g., two PUSCHs in example 500). As further shown in FIG. 5, each PUSCH transmission may be associated with a TB that the UE 120 will encode with one or more CBGs (e.g., as described above in connection with FIG. 4).

Additionally, the DCI 501 schedules, in one or more subsequent slots, one or more additional PUSCH transmissions (e.g., up to PUSCHs X-1 and X in slot N, where X and N are both positive integers). As further shown in FIG. 5, each PUSCH transmission may be associated with a TB that the UE 120 will encode with one or more CBGs (e.g., as described above in connection with FIG. 4).

In some situations, a network entity may configure a UE to transmit using at least two codewords. Using two codewords, for example, allows the UE to transmit two TBs in parallel (e.g., overlapping in time) when using a time domain duplex (TDD) scheme.

Some techniques and apparatuses described herein enable a network entity (e.g., network entity 601, base station 110, CU 310, DU 330, RU 340, and/or apparatus 1400 of FIG. 14) to use DCI to schedule transmissions from a UE (e.g., UE 120 and/or apparatus 1300 of FIG. 13) using at least two codewords. For example, some techniques and apparatuses described herein enable the network entity 601 to encode a CBGTI within the DCI to indicate which CBGs the UE 120 should include. As a result, the network entity 601 increases throughput from the UE 120, which reduces latency and conserves power and processing resources. Additionally, or alternatively, some techniques and apparatuses described herein enable the network entity 601 to indicate MCSs, new data indicators (NDIs), and redundancy versions (RVs) in DCI when scheduling multiple PUSCHs associated with at least two codewords. As a result, the network entity 601 increases throughput from the UE 120, which reduces latency and conserves power and processing resources.

As indicated above, FIG. 5 is provided as an example. Other examples may differ from what is described with respect to FIG. 5.

FIG. 6 is a diagram illustrating an example 600 associated with transmitting and using DCI for CBG transmission, in accordance with the present disclosure. As shown in FIG. 6, a network entity 601 (e.g., an RU 340 and/or a device controlling the RU 340, such as a CU 310 and/or DU 330) and a UE 120 may communicate with one another (e.g., on a wireless network, such as wireless network 100 of FIG. 1).

As shown by reference number 605, the UE 120 may transmit, and the network entity 601 may receive (e.g., directly or via an RU 340 controlled by the network entity 601), a capability message. For example, the UE 120 may transmit a UECapabilityInformation RRC message, as defined in 3GPP specifications and/or another standard. In some aspects, the network entity 601 may transmit (e.g., directly or via an RU 340 controlled by the network entity 601) a (JECapabilityEnquiry RRC message, as defined in 3GPP specifications and/or another standard, such that the UECapabilityInformation RRC message is in response to the (JECapabilityEnquiry RRC message. The capability message may indicate that the UE 120 can transmit using more than one codeword. Additionally, the capability message may indicate that the UE 120 can perform CBG transmission.

Accordingly, as shown by reference number 610, the network entity 601 may transmit (e.g., directly or via an RU 340 controlled by the network entity 601), and the UE 120 may receive, an RRC message indicating a quantity of codewords to use and a quantity of CBGs per TB. For example, the network entity 601 may transmit an RRC message including a maxNrofCode WordsScheduledByDCI data structure and a maxCodeBlockGroupsPer TransportBlock data structure, as defined in 3GPP specifications and/or another standard. Accordingly, the network entity 601 may indicate that at least two codewords can be used for uplink (e.g., using the maxNrofCode WordsScheduledByDCI data structure). As described below, a quantity of bits used for a CBGTI field may be based on the quantity of codewords and the quantity of CBGs per TB. Therefore, as described below, the quantity of CBGs per TB (e.g., indicated in the maxCodeBlockGroupsPer TransportBlock data structure) may be selected based, at least in part in, on the quantity of codewords.

Additionally, in some aspects, the network entity 601 may indicate a quantity of CBGs across codewords. For example, the network entity 601 may transmit an RRC message including a maxCodeBlockGroupsForAllCodeWords data structure to be defined in 3GPP specifications and/or another standard. Accordingly, as described below, a quantity of bits to be used for a CBGTI field may be based on the quantity of CBGs across codewords. Therefore, the quantity of CBGs per TB may be determined based, at least in part, on a scheduled quantity of codewords.

In some aspects, the network entity 601 may enable multiple codewords and/or CBG transmission based on the capability message. Additionally, or alternatively, the network entity 601 may enable multiple codewords and/or CBG transmission unless the capability message indicates the UE 120 is not configured for multiple codewords and/or CBG transmission, respectively.

As shown by reference number 615, the network entity 601 may determine a quantity of bits for a CBGTI field in DCI to be transmitted to the UE 120. In one example, the quantity of bits may be subject to a maximum of 8. Accordingly, when the quantity of codewords is 1, the quantity of CBGs per TB may be set in a range from 1 to 8 such that the quantity of bits in the CBGTI field does not exceed 8. However, when the quantity of codewords is 2, the quantity of CBGs per TB may be set in a range from 1 to 4 such that the quantity of bits in the CBGTI field does not exceed 8.

Alternatively, the quantity of bits may be increased beyond 8 when more than one codeword is used. For example, when the quantity of codewords is 2, the quantity of CBGs per TB may be set in a range from 1 to 8 such that the quantity of bits in the CBGTI field can be up to 16 bits.

In the examples above, the quantity of bits is determined based on RRC parameters. Additionally, the quantity of CBGs per TB is determined based on a configured quantity of codewords. Alternatively, the quantity of CBGs per TB may be determined based on how many codewords are actually scheduled by the DCI. For example, when the network entity 601 is scheduling using one codeword, and the quantity of bits is up to Nₘₐₓ, where Nₘₐₓ represents the quantity of CBGs across codewords (e.g., indicated in the maxCodeBlockGroupsFor AllCodeWords data structure), then the quantity of CBGs per TB may be up to Nₘₐₓ. However, when the network entity 601 is scheduling using two codewords, and the quantity of bits is Nₘₐₓ, where Nₘₐₓ represents the quantity of CBGs across codewords (e.g., indicated in the maxCodeBlockGroupsFor AllCode Words data structure), then the quantity of CBGs per TB may be up to Nₘₐₓ/2.

In some aspects, the network entity 601 may use an MCS field (e.g., set to a codepoint of 26) and/or an RV field (e.g., set to a codepoint of 1) in the DCI to disable one codeword when two codewords were configured via RRC (e.g., the quantity of codewords indicated in the maxNrofCodeWordsScheduledByDCI data structure is two). Additionally, or alternatively, the network entity 601 may indicate that the UE 120 should use one layer for transmitting in the DCI to disable one codeword. For example, the UE 120 generally only uses two codewords when more than one layer is used. As used herein, a “layer” refers to a logical grouping of one or more antenna ports. As an alternative, the network entity 601 may indicate that the UE 120 should use a two, three, or four layers for transmitting in the DCI to disable one codeword. For example, the UE 120 may be programmed (and/or other configured) to only to use two codewords when more than four layers are used.

When the DCI is associated with two codewords, the network entity 601 may be programmed (and/or otherwise configured) to include an uplink scheduling indicator that indicates an uplink transmission with data is scheduled. For example, the network entity 601 may be configured to set a UL-SCH field to ‘1’ whenever using two codewords such that the UE 120 does not expect to be scheduled an uplink transmission without data using DCI that indicates with two MCSs (e.g., even when the other of the two codewords is used to encode a channel state information (CSI) report).

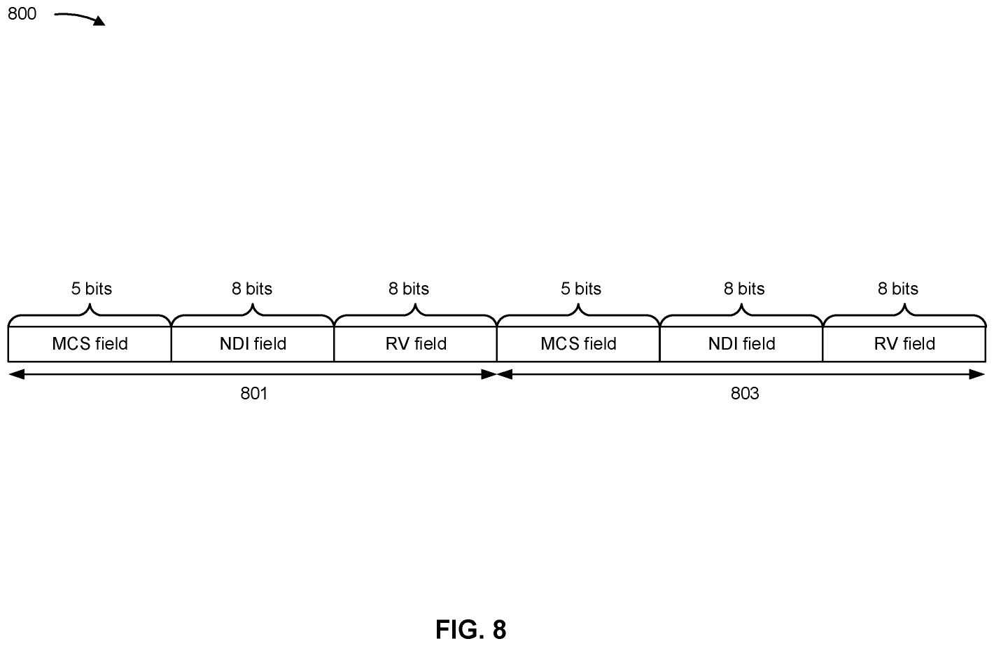

Alternatively, when the DCI is associated with two codewords, the network entity 601 may be permitted to include an uplink scheduling indicator that indicates an uplink transmission without data is scheduled. Accordingly, the UE 120 will discard an MCS, an RV, and an NDI associated with a second of the two codewords (e.g., as described in connection with FIG. 8). For example, the UE 120 may use most significant bits (MSBs) in an MCS field to select the MCS to use for transmitting a CSI report according to the DCI. Similarly, the UE 120 may use MSBs in an RV field to select the RV to use for transmitting the CSI report. Alternatively, the UE 120 may use least significant bits (LSBs) in an MCS field to select the MCS to use for transmitting a CSI report according to the DCI. Similarly, the UE 120 may use LSBs in an RV field to select the RV to use for transmitting the CSI report.

Accordingly, as shown by reference number 620, the network entity 601 may transmit (e.g., directly or via an RU 340 controlled by the network entity 601), and the UE 120 may receive, DCI that includes the CBGTI field. In some aspects, the DCI may additional indicate one or more MCSs, RVs, and/or NDIs, as described in connection with FIG. 8. The DCI may schedule a single PUSCH transmission or multiple PUSCH transmissions (e.g., as described in connection with FIGS. 5 and 8).

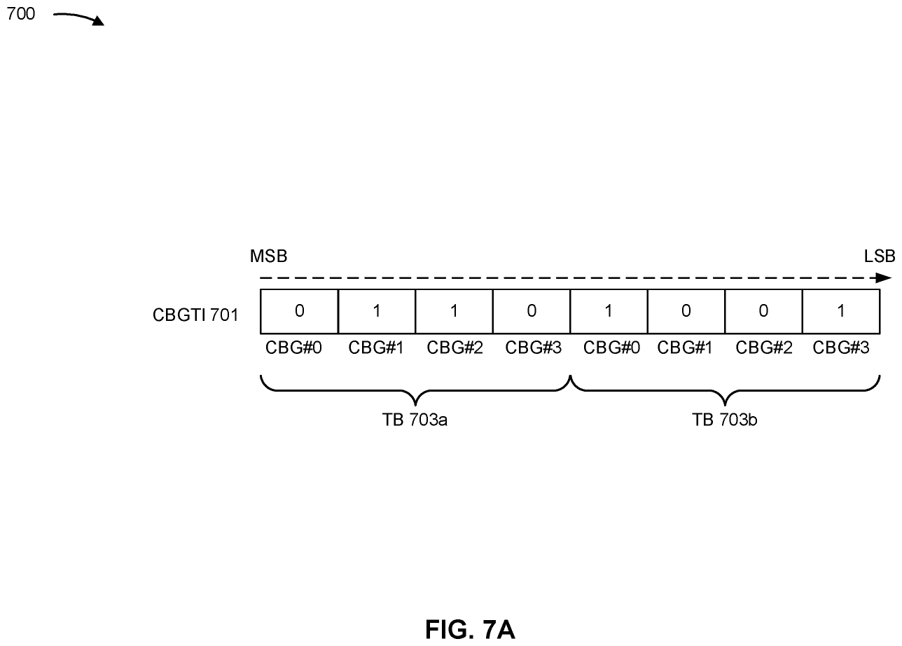

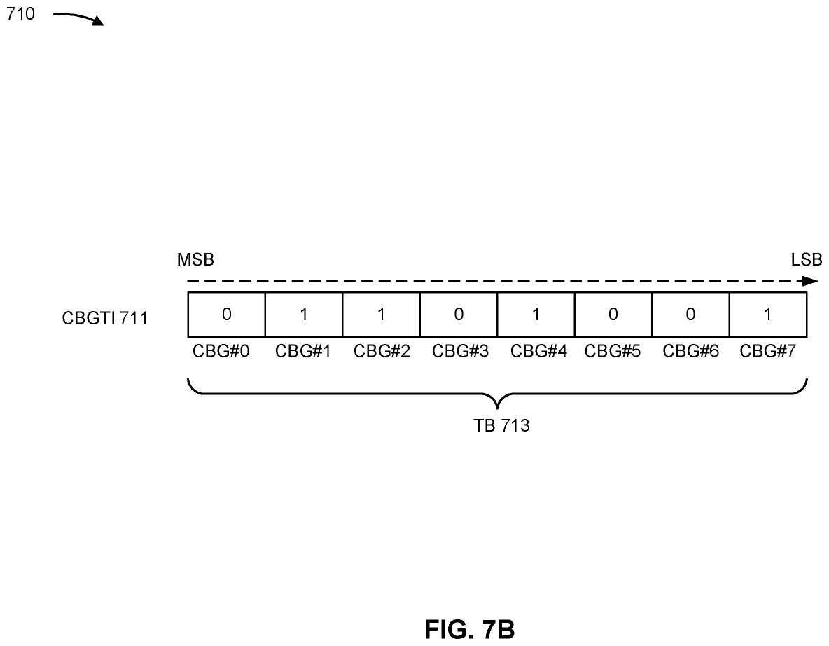

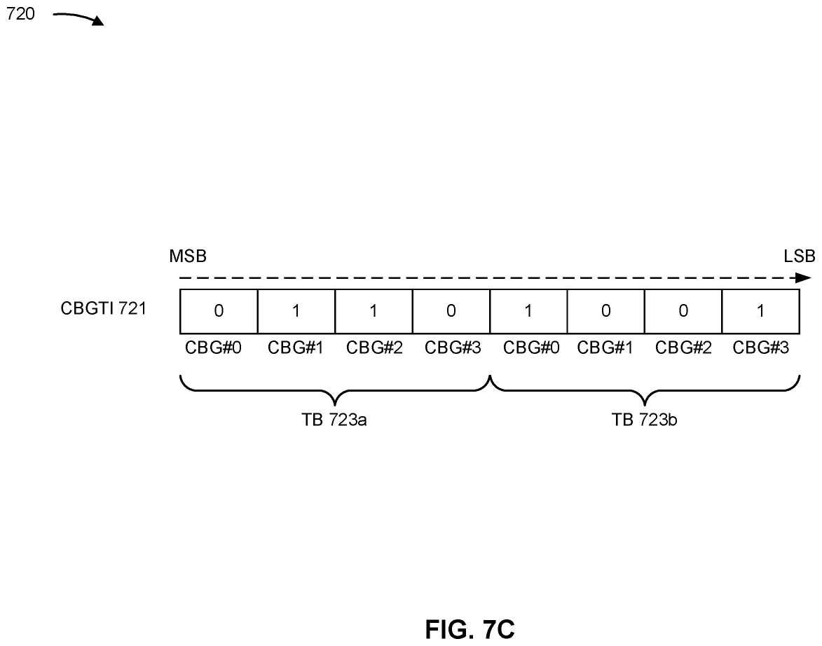

As shown by reference number 625, the UE 120 may transmit, and the network entity 601 may receive (e.g., directly or via an RU 340 controlled by the network entity 601), on the PUSCH(s) according to the DCI. For example, the UE 120 may map CBGs to one or more TBs, as described in connection with FIGS. 7A-7C, and transmit the TB(s) to the network entity 601 (e.g., OTA).

By using techniques as described in connection with FIG. 6, the network entity 601 encodes a CBGTI within the DCI to indicate which CBGs the UE 120 should include. As a result, the network entity 601 increases throughput from the UE 120, which reduces latency and conserves power and processing resources.

As indicated above, FIG. 6 is provided as an example. Other examples may differ from what is described with respect to FIG. 6.

FIGS. 7A, 7B, and 7C are diagrams illustrating examples 700, 710, and 720, respectively, associated with mapping DCI bits to CBGs, in accordance with the present disclosure. As shown in FIG. 7A, example 700 includes a CBGTI field 701 from MSB to LSB associated with two codewords. Accordingly, the CBGTI field 701 has a length N_{TB}·N bits, where N_{TB} represents the quantity of codewords (e.g., indicated by the data structure maxNrofCodeWordsScheduledByDCI), and N represents the quantity of CBGs per TB (e.g., indicated by the data structure maxCodeBlockGroupsPerTransportBlock). Accordingly, a UE (e.g., UE 120) maps CBGs into a first TB 703a, encoded using the first codeword, based on a sequence of a first set of N bits starting from the MSB of the CBGTI field 701. Accordingly, the first TB 703a includes CBGs with indices 1 and 2 because the second and third bits in the first set of N bits are activated. If the UE 120 has fewer CBGs to transmit than N (e.g., a quantity of CBGs M<N), the UE 120 disregards bits beyond the first M bits in the first set of N bits. Similarly, the UE 120 maps CBGs into a second TB 703b, encoded using the second codeword, based on a sequence of a second set of N bits ending at the LSB of the CBGTI field 701. Accordingly, the second TB 703b includes CBGs with indices 0 and 3 because the first and fourth bits in the second set of N bits are activated. If the UE 120 has fewer CBGs to transmit than N (e.g., a quantity of CBGs M<N), the UE 120 disregards bits beyond the first M bits in the second set of N bits.

As shown in FIG. 7B, example 710 includes a CBGTI field 711 from MSB to LSB when one codeword is scheduled. Accordingly, the CBGTI field 711 has a length Nₘₐₓ, where Nₘₐₓ represents the quantity of CBGs across codewords (e.g., indicated by the data structure maxCodeBlockGroupsForAllCodeWords). Accordingly, the UE 120 maps CBGs into a TB 713, encoded using the codeword, based on a sequence starting from the MSB and ending at the LSB of the CBGTI field 711. Accordingly, the TB 713 includes CBGs with indices 1, 2, 4, and 7 because the second, third, fifth, and eighth bits are activated. If the UE 120 has fewer CBGs to transmit than N (e.g., a quantity of CBGs M<Nₘₐₓ), the UE 120 disregards bits beyond the first M bits in the bits of the CBGTI field 711.

As shown in FIG. 7C, example 720 includes a CBGTI field 721 from MSB to LSB when two codewords are scheduled. Accordingly, the CBGTI field 721 has a length Nₘₐₓ and the CBGTI field for each TB has a length Nₘₐₓ/2, where Nₘₐₓ represents the quantity of CBGs across codewords (e.g., indicated by the data structure maxCodeBlockGroupsForAllCode Words). Accordingly, the UE 120 maps CBGs into a first TB 723a, encoded using the first codeword, based on a sequence of a first set of Nₘₐₓ/2 bits starting from the MSB of the CBGTI field 721. Accordingly, the first TB 723a includes CBGs with indices 1 and 2 because the second and third bits in the first set of Nₘₐₓ/2 bits are activated. If the UE 120 has fewer CBGs to transmit than Nₘₐₓ/2 (e.g., a quantity of CBGs M<Nₘₐₓ/2), the UE 120 disregards bits beyond the first M bits in the first set of Nₘₐₓ/2 bits. Similarly, the UE 120 maps CBGs into a second TB 723b, encoded using the second codeword, based on a sequence of a second set of Nₘₐₓ/2 bits ending at the LSB of the CBGTI field 721. Accordingly, the second TB 723b includes CBGs with indices 0 and 3 because the first and fourth bits in the second set of Nₘₐₓ/2 bits are activated. If the UE 120 has fewer CBGs to transmit than Nₘₐₓ/2 (e.g., a quantity of CBGs M<Nₘₐₓ/2), the UE 120 disregards bits beyond the first M bits in the second set of Nₘₐₓ/2 bits.

As indicated above, FIGS. 7A-7C are provided as examples. Other examples may differ from what is described with respect to FIGS. 7A-7C.

FIG. 8 is a diagram illustrating an example 800 associated with DCI fields for multiple PUSCH transmissions, in accordance with the present disclosure. As shown in FIG. 8, example 800 includes a first portion 801 of DCI fields (e.g., encoded by a network entity 601) to indicate an MCS, RVs, and NDIs for a first codeword of a plurality of PUSCHs that are scheduled by the DCI. For example, the MCS may be indicated using up to 5 bits and may apply across all PUSCH transmissions using the first codeword. The RVs may be indicated using a plurality of bits, where each bit of the plurality of bits corresponds to a PUSCH of the plurality of PUSCHs. Therefore, the RVs may be indicated using a quantity of bits equal to the quantity of PUSCHs. In example 800, the DCI may schedule up to 8 PUSCHs, so the RVs may be indicated using up to 8 bits. Similarly, the NDIs may be indicated using a plurality of bits, where each bit of the plurality of bits corresponds to a PUSCH of the plurality of PUSCHs. Therefore, the NDIs may be indicated using a quantity of bits equal to the quantity of PUSCHs. In example 800, the DCI may schedule up to 8 PUSCHs, so the NDIs may be indicated using up to 8 bits.

As further shown in FIG. 8, example 800 includes a second portion 803 of DCI fields (e.g., encoded by the network entity 601) to indicate an MCS, RVs, and NDIs for a second codeword of a plurality of PUSCHs that are scheduled by the DCI. For example, the MCS may be indicated using up to 5 bits and may apply across all PUSCH transmissions using the second codeword. The RVs may be indicated using a plurality of bits, where each bit of the plurality of bits corresponds to a PUSCH of the plurality of PUSCHs. Therefore, the RVs may be indicated using a quantity of bits equal to the quantity of PUSCHs. In example 800, the DCI may schedule up to 8 PUSCHs, so the RVs may be indicated using up to 8 bits. Similarly, the NDIs may be indicated using a plurality of bits, where each bit of the plurality of bits corresponds to a PUSCH of the plurality of PUSCHs. Therefore, the NDIs may be indicated using a quantity of bits equal to the quantity of PUSCHs. In example 800, the DCI may schedule up to 8 PUSCHs, so the NDIs may be indicated using up to 8 bits.

By using techniques as described in connection with FIG. 8, the network entity 601 indicates MCSs, NDIs, and RVs in DCI when scheduling multiple PUSCHs associated with at least two codewords. As a result, the network entity 601 increases throughput from a UE (e.g., UE 120), which reduces latency and conserves power and processing resources.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120 and/or apparatus 1300 of FIG. 13) performs operations associated with using DCI for CBG transmission.

As shown in FIG. 9, in some aspects, process 900 may include receiving DCI that schedules a PUSCH, wherein the DCI includes a CBGTI field that includes a quantity of bits based on a quantity of codewords configured for the UE (block 910). For example, the UE (e.g., using communication manager 140 and/or reception component 1302, depicted in FIG. 13) may receive DCI that schedules a PUSCH, wherein the DCI includes a CBGTI field that includes a quantity of bits based on a quantity of codewords configured for the UE, as described herein.

As further shown in FIG. 9, in some aspects, process 900 may include transmitting on the PUSCH according to the DCI (block 920). For example, the UE (e.g., using communication manager 140 and/or transmission component 1304, depicted in FIG. 13) may transmit on the PUSCH according to the DCI, as described herein.

Process 900 may include additional aspects, such as any single aspect or any combination of aspects described below and/or in connection with one or more other processes described elsewhere herein.

In a first aspect, the DCI is encoded according to format 0_1.

In a second aspect, alone or in combination with the first aspect, process 900 further includes receiving (e.g., using communication manager 140 and/or reception component 1302) an RRC message indicating the quantity of codewords.

In a third aspect, alone or in combination with one or more of the first and second aspects, the quantity of bits is further based on a quantity of CBGs per TB.

In a fourth aspect, alone or in combination with one or more of the first through third aspects, the quantity of bits is subject to a maximum of 8 and the quantity of CBGs per TB is subject to a maximum of 4, or the quantity of bits is subject to a maximum of 16 and the quantity of CBGs per TB is subject to a maximum of 8.

In a fifth aspect, alone or in combination with one or more of the first through fourth aspects, process 900 further includes receiving (e.g., using communication manager 140 and/or reception component 1302) an RRC message indicating a quantity of CBGs across codewords such that the quantity of bits is further based on the quantity of CBGs across codewords.

In a sixth aspect, alone or in combination with one or more of the first through fifth aspects, the DCI indicates the quantity of codewords.

In a seventh aspect, alone or in combination with one or more of the first through sixth aspects, the quantity of codewords is equal to 1 based at least in part on one or more of: an MCS field of the DCI being equal to 26 and an RV field of the DCI being equal to 1, a quantity of layers indicated in the DCI being equal to 1, or the quantity of layers indicated in the DCI being less than or equal to 4.

In an eighth aspect, alone or in combination with one or more of the first through seventh aspects, one or more CBGs are transmitted that correspond to bits in the CBGTI field sequentially from most significant bit to least significant bit.

In a ninth aspect, alone or in combination with one or more of the first through eighth aspects, one or more CBGs are transmitted that are associated with a first TB and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

In a tenth aspect, alone or in combination with one or more of the first through ninth aspects, one or more CBGs are transmitted that are associated with a first TB and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

In an eleventh aspect, alone or in combination with one or more of the first through tenth aspects, the DCI is associated with two codewords, and the DCI includes an uplink scheduling indicator that indicates an uplink transmission with data is scheduled.

In a twelfth aspect, alone or in combination with one or more of the first through eleventh aspects, the DCI is associated with two codewords, and the DCI includes an uplink scheduling indicator that indicates an uplink transmission without data is scheduled.

In a thirteenth aspect, alone or in combination with one or more of the first through twelfth aspects, process 900 further includes selecting (e.g., using communication manager 140 and/or determination component 1308, depicted in FIG. 13) one MCS, from two MCSs indicated by the DCI, for transmitting on the PUSCH.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network entity 601 and/or apparatus 1400 of FIG. 14) performs operations associated with transmitting DCI for CBG transmission.

As shown in FIG. 10, in some aspects, process 1000 may include transmitting DCI that schedules a PUSCH, wherein the DCI includes a CBGTI field that includes a quantity of bits based on a quantity of codewords configured for the UE (e.g., UE 120 and/or apparatus 1300 of FIG. 13) (block 1010). For example, the network entity (e.g., using communication manager 150 and/or transmission component 1404, depicted in FIG. 14) may transmit DCI that schedules a PUSCH, wherein the DCI includes a CBGTI field that includes a quantity of bits based on a quantity of codewords configured for a UE, as described herein.

As further shown in FIG. 10, in some aspects, process 1000 may include receiving on the PUSCH according to the DCI (block 1020). For example, the network entity (e.g., using communication manager 150 and/or reception component 1402, depicted in FIG. 14) may receive on the PUSCH according to the DCI, as described herein.

Process 1000 may include additional aspects, such as any single aspect or any combination of aspects described below and/or in connection with one or more other processes described elsewhere herein.

In a first aspect, the DCI is encoded according to format 0_1.

In a second aspect, alone or in combination with the first aspect, process 1000 further includes transmitting (e.g., using communication manager 150 and/or transmission component 1404) an RRC message indicating the quantity of codewords.

In a third aspect, alone or in combination with one or more of the first and second aspects, the quantity of bits is further based on a quantity of CBGs per TB.

In a fourth aspect, alone or in combination with one or more of the first through third aspects, the quantity of bits is subject to a maximum of 8 and the quantity of CBGs per TB is subject to a maximum of 4, or the quantity of bits is subject to a maximum of 16 and the quantity of CBGs per TB is subject to a maximum of 8.

In a fifth aspect, alone or in combination with one or more of the first through fourth aspects, process 1000 further includes transmitting (e.g., using communication manager 150 and/or transmission component 1404) an RRC message indicating a quantity of CBGs across codewords such that the quantity of bits is further based on the quantity of CBGs across codewords.

In a sixth aspect, alone or in combination with one or more of the first through fifth aspects, the DCI indicates the quantity of codewords.

In a seventh aspect, alone or in combination with one or more of the first through sixth aspects, the quantity of codewords is equal to 1 based at least in part on one or more of: an MCS field of the DCI being equal to 26 and an RV field of the DCI being equal to 1, a quantity of layers indicated in the DCI being equal to 1, or the quantity of layers indicated in the DCI being less than or equal to 4.

In an eighth aspect, alone or in combination with one or more of the first through seventh aspects, one or more CBGs are received that correspond to bits in the CBGTI field sequentially from most significant bit to least significant bit.

In a ninth aspect, alone or in combination with one or more of the first through eighth aspects, one or more CBGs are received that are associated with a first TB and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

In a tenth aspect, alone or in combination with one or more of the first through ninth aspects, one or more CBGs are received that are associated with a first TB and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

In an eleventh aspect, alone or in combination with one or more of the first through tenth aspects, the DCI is associated with two codewords, and the DCI includes an uplink scheduling indicator that indicates an uplink transmission with data is scheduled.

In a twelfth aspect, alone or in combination with one or more of the first through eleventh aspects, the DCI is associated with two codewords, and the DCI includes an uplink scheduling indicator that indicates an uplink transmission without data is scheduled.

In a thirteenth aspect, alone or in combination with one or more of the first through twelfth aspects, process 1000 further includes selecting (e.g., using communication manager 150 and/or scheduling component 1408, depicted in FIG. 14) one MCS, from two MCSs indicated by the DCI, for receiving on the PUSCH.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120 and/or apparatus 1300 of FIG. 13) performs operations associated with using DCI for CBG transmission.

As shown in FIG. 11, in some aspects, process 1100 may include receiving a control message indicating two codewords transmission are enabled (block 1110). For example, the UE (e.g., using communication manager 140 and/or reception component 1302, depicted in FIG. 13) may receive a control message indicating two codewords transmission are enabled, as described herein.

As further shown in FIG. 11, in some aspects, process 1100 may include receiving DCI that schedules a plurality of PUSCHs, wherein the DCI indicates a first MCS for a first codeword of the plurality of PUSCHs and a second MCS for a second codeword of the plurality of PUSCHs (block 1120). For example, the UE (e.g., using communication manager 140 and/or reception component 1302) may receive DCI that schedules a plurality of PUSCHs, wherein the DCI indicates a first MCS for a first codeword of the plurality of PUSCHs and a second MCS for a second codeword of the plurality of PUSCHs, as described herein.

As further shown in FIG. 11, in some aspects, process 1100 may include transmitting on the plurality of PUSCHs according to the DCI (block 1130). For example, the UE (e.g., using communication manager 140 and/or transmission component 1304, depicted in FIG. 13) may transmit on the plurality of PUSCHs according to the DCI, as described herein.

Process 1100 may include additional aspects, such as any single aspect or any combination of aspects described below and/or in connection with one or more other processes described elsewhere herein.

In a first aspect, the DCI includes a first plurality of NDIs corresponding to the first codeword of the plurality of PUSCHs and a second plurality of NDIs corresponding to the second codeword of the plurality of PUSCHs.

In a second aspect, alone or in combination with the first aspect, the DCI includes a first plurality of RV indications corresponding to the first codeword of the plurality of PUSCHs and a second plurality of RV indications corresponding to the second codeword of the plurality of PUSCHs.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., network entity 601 and/or apparatus 1400 of FIG. 14) performs operations associated with transmitting DCI for CBG transmission.

As shown in FIG. 12, in some aspects, process 1200 may include transmitting a control message indicating two codewords transmission are enabled for a UE (e.g., UE 120 and/or apparatus 1300 of FIG. 13) (block 1210). For example, the network entity (e.g., using communication manager 150 and/or transmission component 1404, depicted in FIG. 14) may transmit a control message indicating two codewords transmission are enabled for a UE, as described herein.

As further shown in FIG. 12, in some aspects, process 1200 may include transmitting DCI that schedules a plurality of PUSCHs, wherein the DCI indicates a first MCS for a first codeword of the plurality of PUSCHs and a second MCS for a second codeword of the plurality of PUSCHs (block 1220). For example, the network entity (e.g., using communication manager 150 and/or transmission component 1404) may transmit DCI that schedules a plurality of PUSCHs, wherein the DCI indicates a first MCS for a first codeword of the plurality of PUSCHs and a second MCS for a second codeword of the plurality of PUSCHs, as described herein.

As further shown in FIG. 12, in some aspects, process 1200 may include receiving on the plurality of PUSCHs according to the DCI (block 1230). For example, the network entity (e.g., using communication manager 150 and/or reception component 1402, depicted in FIG. 14) may receive on the plurality of PUSCHs according to the DCI, as described herein.

Process 1200 may include additional aspects, such as any single aspect or any combination of aspects described below and/or in connection with one or more other processes described elsewhere herein.

In a first aspect, the DCI includes a first plurality of NDIs corresponding to the first codeword of the plurality of PUSCHs and a second plurality of NDIs corresponding to the second codeword of the plurality of PUSCHs.

In a second aspect, alone or in combination with the first aspect, the DCI includes a first plurality of RV indications corresponding to the first codeword of the plurality of PUSCHs and a second plurality of RV indications corresponding to the second codeword of the plurality of PUSCHs.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a determination component 1308, among other examples.

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the reception component 1302 may receive (e.g., from the apparatus 1306, such as a network entity) DCI that schedules a PUSCH. The DCI includes a CBGTI field that includes a quantity of bits based on a quantity of codewords configured for the apparatus 1300 (e.g., by the apparatus 1306). Accordingly, the transmission component 1304 may transmit (e.g., to the apparatus 1306) on the PUSCH according to the DCI.

In some aspects, the reception component 1302 may receive (e.g., from the apparatus 1306) an RRC message indicating the quantity of codewords. Additionally, or alternatively, the reception component 1302 may receive (e.g., from the apparatus 1306) an RRC message indicating a quantity of CBGs across codewords, where the quantity of bits is further based on the quantity of CBGs across codewords. In some aspects, the determination component 1308 may select one MCS, from two MCSs indicated by the DCI, for transmitting on the PUSCH. The determination component 1308 may include a modulator, a transmit MIMO processor, a transmit processor, a controller/processor, a memory, or a combination thereof, of the UE described in connection with FIG. 2.

Additionally, or alternatively, the reception component 1302 may receive (e.g., from the apparatus 1306, such as a network entity) a control message indicating two codewords transmission are enabled. Further, the reception component 1302 may receive (e.g., from the apparatus 1306) DCI that schedules a plurality of PUSCHs. The DCI indicates a first MCS for a first codeword of the plurality of PUSCHs and a second MCS for a second codeword of the plurality of PUSCHs. Accordingly, the transmission component 1304 may transmit (e.g., to the apparatus 1306) on the plurality of PUSCHs according to the DCI.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network entity, or a network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a scheduling component 1408, among other examples.

In some aspects, the apparatus 1400 may be configured to perform one or more operations described herein in connection with FIGS. 6-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

In some aspects, the transmission component 1404 may transmit (e.g., to the apparatus 1406, such as a UE) DCI that schedules a PUSCH. The DCI includes a CBGTI field that includes a quantity of bits based on a quantity of codewords configured for the apparatus 1406. Accordingly, the reception component 1402 may receive (e.g., form the apparatus 1406) on the PUSCH according to the DCI.

In some aspects, the transmission component 1404 may transmit (e.g., to the apparatus 1406) an RRC message indicating the quantity of codewords. Additionally, or alternatively, the transmission component 1404 may transmit (e.g., to the apparatus 1406) an RRC message indicating a quantity of CBGs across codewords, where the quantity of bits is further based on the quantity of CBGs across codewords. In some aspects, the scheduling component 1408 may select one MCS, from two MCSs indicated by the DCI, for receiving on the PUSCH. The scheduling component 1408 may include a demodulator, a MIMO detector, a receive processor, a controller/processor, a memory, or a combination thereof, of the base station described in connection with FIG. 2.

Additionally, or alternatively, the transmission component 1404 may transmit (e.g., to the apparatus 1406, such as a UE) a control message indicating two codewords transmission are enabled for the apparatus 1406. Further, the transmission component 1404 may transmit (e.g., to the apparatus 1406) DCI that schedules a plurality of PUSCHs. The DCI indicates a first MCS for a first codeword of the plurality of PUSCHs and a second MCS for a second codeword of the plurality of PUSCHs. Accordingly, the reception component 1402 may receive (e.g., from the apparatus 1406) on the plurality of PUSCHs according to the DCI.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving downlink control information (DCI) that schedules a physical uplink shared channel (PUSCH), wherein the DCI includes a code block group (CBG) transmission information (CBGTI) field that includes a quantity of bits based on a quantity of codewords configured for the UE; and transmitting on the PUSCH according to the DCI.

Aspect 2: The method of Aspect 1, wherein the DCI is encoded according to format 0_1.

Aspect 3: The method of any of Aspects 1 through 2, further comprising: receiving a radio resource control (RRC) message indicating the quantity of codewords.

Aspect 4: The method of any of Aspects 1 through 3, wherein the quantity of bits is further based on a quantity of CBGs per transport block (TB).

Aspect 5: The method of Aspect 4, wherein the quantity of bits is subject to a maximum of 8 and the quantity of CBGs per TB is subject to a maximum of 4, or the quantity of bits is subject to a maximum of 16 and the quantity of CBGs per TB is subject to a maximum of 8.

Aspect 6: The method of any of Aspects 1 through 2, further comprising: receiving a radio resource control (RRC) message indicating a quantity of CBGs across codewords, wherein the quantity of bits is further based on the quantity of CBGs across codewords.

Aspect 7: The method of any of Aspects 1, through 6 wherein the DCI indicates the quantity of codewords.

Aspect 8: The method of Aspect 7, wherein the quantity of codewords is equal to 1 based at least in part on one or more of: a modulation and coding scheme (MCS) field of the DCI being equal to 26, and a redundancy version (RV) field of the DCI being equal to 1; a quantity of layers indicated in the DCI being equal to 1; or the quantity of layers indicated in the DCI being less than or equal to 4.

Aspect 9: The method of any of Aspects 1 through 8, wherein one or more CBGs are transmitted that correspond to bits in the CBGTI field sequentially from most significant bit to least significant bit.

Aspect 10: The method of any of Aspects 1 through 9, wherein one or more CBGs are transmitted that are associated with a first transport block (TB) and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

Aspect 11: The method of any of Aspects 1 through 9, wherein one or more CBGs are transmitted that are associated with a first transport block (TB) and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

Aspect 12: The method of any of Aspects 1 through 11, wherein the DCI is associated with two codewords, and the DCI includes an uplink scheduling indicator that indicates an uplink transmission with data is scheduled.

Aspect 13: The method of any of Aspects 1 through 8, wherein the DCI is associated with two codewords, and the DCI includes an uplink scheduling indicator that indicates an uplink transmission without data is scheduled.

Aspect 14: The method of Aspect 13, further comprising: selecting one modulation and coding scheme (MCS), from two MCSs indicated by the DCI, for transmitting on the PUSCH.

Aspect 15: A method of wireless communication performed by a network entity, comprising: transmitting downlink control information (DCI) that schedules a physical uplink shared channel (PUSCH), wherein the DCI includes a code block group (CBG) transmission information (CBGTI) field that includes a quantity of bits based on a quantity of codewords configured for a user equipment (UE); and receiving on the PUSCH according to the DCI.

Aspect 16: The method of Aspect 15, wherein the DCI is encoded according to format 0_1.

Aspect 17: The method of any of Aspects 15 through 16, further comprising: transmitting a radio resource control (RRC) message indicating the quantity of codewords.

Aspect 18: The method of any of Aspects 15 through 17, wherein the quantity of bits is further based on a quantity of CBGs per transport block (TB).

Aspect 19: The method of Aspect 18, wherein the quantity of bits is subject to a maximum of 8 and the quantity of CBGs per TB is subject to a maximum of 4, or the quantity of bits is subject to a maximum of 16 and the quantity of CBGs per TB is subject to a maximum of 8.

Aspect 20: The method of any of Aspects 15 through 16, further comprising: transmitting a radio resource control (RRC) message indicating a quantity of CBGs across codewords, wherein the quantity of bits is further based on the quantity of CBGs across codewords.

Aspect 21: The method of any of Aspects 15 through 20, wherein the DCI indicates the quantity of codewords.

Aspect 22: The method of Aspect 21, wherein the quantity of codewords is equal to 1 based at least in part on one or more of: a modulation and coding scheme (MCS) field of the DCI being equal to 26, and a redundancy version (RV) field of the DCI being equal to 1; a quantity of layers indicated in the DCI being equal to 1; or the quantity of layers indicated in the DCI being less than or equal to 4.

Aspect 23: The method of any of Aspects 15 through 22, wherein one or more CBGs are received that correspond to bits in the CBGTI field sequentially from most significant bit to least significant bit.

Aspect 24: The method of any of Aspects 15 through 23, wherein one or more CBGs are received that are associated with a first transport block (TB) and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

Aspect 25: The method of any of Aspects 15 through 23, wherein one or more CBGs are received that are associated with a first transport block (TB) and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

Aspect 26: The method of any of Aspects 15 through 25, wherein the DCIis associated with two codewords, and the DCI includes an uplink scheduling indicator that indicates an uplink transmission with data is scheduled.

Aspect 27: The method of any of Aspects 15 through 22, wherein the DCIis associated with two codewords, and the DCI includes an uplink scheduling indicator that indicates an uplink transmission without data is scheduled.

Aspect 28: The method of Aspect 27, further comprising: selecting one modulation and coding scheme (MCS), from two MCSs indicated by the DCI, for receiving on the PUSCH.

Aspect 29: A method of wireless communication performed by a user equipment (UE), comprising: receiving a control message indicating two codewords transmission are enabled; receiving downlink control information (DCI) that schedules a plurality of physical uplink shared channels (PUSCHs), wherein the DCI indicates a first modulation and coding scheme (MCS) for a first codeword of the plurality of PUSCHs and a second MCS for a second codeword of the plurality of PUSCHs; and transmitting on the plurality of PUSCHs according to the DCI.

Aspect 30: The method of Aspect 29, wherein the DCI includes a first plurality of new data indicators (NDIs) corresponding to the first codeword of the plurality of PUSCHs and a second plurality of NDIs corresponding to the second codeword of the plurality of PUSCHs.

Aspect 31: The method of any of Aspects 29 through 30, wherein the DCI includes a first plurality of redundancy version (RV) indications corresponding to the first codeword of the plurality of PUSCHs and a second plurality of RV indications corresponding to the second codeword of the plurality of PUSCHs.

Aspect 32: A method of wireless communication performed by a network entity, comprising: transmitting a control message indicating two codewords transmission are enabled for a user equipment (UE); transmitting downlink control information (DCI) that schedules a plurality of physical uplink shared channels (PUSCHs), wherein the DCI indicates a first modulation and coding scheme (MCS) for a first codeword of the plurality of PUSCHs and a second MCS for a second codeword of the plurality of PUSCHs; and receiving on the plurality of PUSCHs according to the DCI.

Aspect 33: The method of Aspect 32, wherein the DCI includes a first plurality of new data indicators (NDIs) corresponding to the first codeword of the plurality of PUSCHs and a second plurality of NDIs corresponding to the second codeword of the plurality of PUSCHs.

Aspect 34: The method of any of Aspects 32 through 33, wherein the DCI includes a first plurality of redundancy version (RV) indications corresponding to the first codeword of the plurality of PUSCHs and a second plurality of RV indications corresponding to the second codeword of the plurality of PUSCHs.

Aspect 35: An apparatus for wireless communication at a device, comprising a processor; memory coupled with the processor; and instructions stored in the memory and executable by the processor to cause the apparatus to perform the method of one or more of Aspects 1-14.

Aspect 36: A device for wireless communication, comprising a memory and one or more processors coupled to the memory, the one or more processors configured to perform the method of one or more of Aspects 1-14.

Aspect 37: An apparatus for wireless communication, comprising at least one means for performing the method of one or more of Aspects 1-14.

Aspect 38: A non-transitory computer-readable medium storing code for wireless communication, the code comprising instructions executable by a processor to perform the method of one or more of Aspects 1-14.

Aspect 39: A non-transitory computer-readable medium storing a set of instructions for wireless communication, the set of instructions comprising one or more instructions that, when executed by one or more processors of a device, cause the device to perform the method of one or more of Aspects 1-14.

Aspect 40: An apparatus for wireless communication at a device, comprising a processor; memory coupled with the processor; and instructions stored in the memory and executable by the processor to cause the apparatus to perform the method of one or more of Aspects 15-28.

Aspect 41: A device for wireless communication, comprising a memory and one or more processors coupled to the memory, the one or more processors configured to perform the method of one or more of Aspects 15-28.

Aspect 42: An apparatus for wireless communication, comprising at least one means for performing the method of one or more of Aspects 15-28.

Aspect 43: A non-transitory computer-readable medium storing code for wireless communication, the code comprising instructions executable by a processor to perform the method of one or more of Aspects 15-28.

Aspect 44: A non-transitory computer-readable medium storing a set of instructions for wireless communication, the set of instructions comprising one or more instructions that, when executed by one or more processors of a device, cause the device to perform the method of one or more of Aspects 15-28.

Aspect 45: An apparatus for wireless communication at a device, comprising a processor; memory coupled with the processor; and instructions stored in the memory and executable by the processor to cause the apparatus to perform the method of one or more of Aspects 29-31.

Aspect 46: A device for wireless communication, comprising a memory and one or more processors coupled to the memory, the one or more processors configured to perform the method of one or more of Aspects 29-31.

Aspect 47: An apparatus for wireless communication, comprising at least one means for performing the method of one or more of Aspects 29-31.

Aspect 48: A non-transitory computer-readable medium storing code for wireless communication, the code comprising instructions executable by a processor to perform the method of one or more of Aspects 29-31.

Aspect 49: A non-transitory computer-readable medium storing a set of instructions for wireless communication, the set of instructions comprising one or more instructions that, when executed by one or more processors of a device, cause the device to perform the method of one or more of Aspects 29-31.

Aspect 50: An apparatus for wireless communication at a device, comprising a processor; memory coupled with the processor; and instructions stored in the memory and executable by the processor to cause the apparatus to perform the method of one or more of Aspects 32-34.

Aspect 51: A device for wireless communication, comprising a memory and one or more processors coupled to the memory, the one or more processors configured to perform the method of one or more of Aspects 32-34.

Aspect 52: An apparatus for wireless communication, comprising at least one means for performing the method of one or more of Aspects 32-34.

Aspect 53: A non-transitory computer-readable medium storing code for wireless communication, the code comprising instructions executable by a processor to perform the method of one or more of Aspects 32-34.

Aspect 54: A non-transitory computer-readable medium storing a set of instructions for wireless communication, the set of instructions comprising one or more instructions that, when executed by one or more processors of a device, cause the device to perform the method of one or more of Aspects 32-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “cither” or “only one of”).

What is claimed is:

1. An apparatus for wireless communication at a user equipment (UE), comprising:
a memory; and
one or more processors, coupled to the memory, configured to:
receive downlink control information (DCI) that schedules a physical uplink shared channel (PUSCH), wherein the DCI includes a code block group (CBG) transmission information (CBGTI) field that includes a quantity of bits based on a quantity of codewords configured for the UE; and
transmit on the PUSCH according to the DCI.

2. The apparatus of claim 1, wherein the DCI is encoded according to format 0_1.

3. The apparatus of claim 1, wherein the one or more processors are further configured to:
receive a radio resource control (RRC) message indicating the quantity of codewords.

4. The apparatus of claim 1, wherein the quantity of bits is further based on a quantity of CBGs per transport block (TB).

5. The apparatus of claim 4, wherein the quantity of bits is subject to a maximum of 8 and the quantity of CBGs per TB is subject to a maximum of 4, or the quantity of bits is subject to a maximum of 16 and the quantity of CBGs per TB is subject to a maximum of 8.

6. The apparatus of claim 1, wherein the one or more processors are further configured to:
receive a radio resource control (RRC) message indicating a quantity of CBGs across codewords,
wherein the quantity of bits is further based on the quantity of CBGs across codewords.

7. The apparatus of claim 1, wherein the DCI indicates the quantity of codewords.

8. The apparatus of claim 7, wherein the quantity of codewords is equal to 1 based at least in part on one or more of:
a modulation and coding scheme (MCS) field of the DCI being equal to 26, and a redundancy version (RV) field of the DCI being equal to 1;
a quantity of layers indicated in the DCI being equal to 1; or
the quantity of layers indicated in the DCI being less than or equal to 4.

9. The apparatus of claim 1, wherein one or more CBGs are transmitted that correspond to bits in the CBGTI field sequentially from most significant bit to least significant bit.

10. The apparatus of claim 1, wherein one or more CBGs are transmitted that are associated with a first transport block (TB) and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

11. The apparatus of claim 1, wherein one or more CBGs are transmitted that are associated with a first transport block (TB) and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

12. The apparatus of claim 1, wherein the DCI is associated with two codewords, and the DCI includes an uplink scheduling indicator that indicates an uplink transmission with data is scheduled.

13. The apparatus of claim 1, wherein the DCI is associated with two codewords, and the DCI includes an uplink scheduling indicator that indicates an uplink transmission without data is scheduled.

14. The apparatus of claim 13, wherein the one or more processors are further configured to:
select one modulation and coding scheme (MCS), from two MCSs indicated by the DCI, for transmitting on the PUSCH.

15. An apparatus for wireless communication at a network entity, comprising:
a memory; and
one or more processors, coupled to the memory, configured to:
transmit downlink control information (DCI) that schedules a physical uplink shared channel (PUSCH), wherein the DCI includes a code block group (CBG) transmission information (CBGTI) field that includes a quantity of bits based on a quantity of codewords configured for a user equipment (UE); and
receive on the PUSCH according to the DCI.

16. The apparatus of claim 15, wherein the DCI is encoded according to format 0_1.

17. The apparatus of claim 15, wherein the one or more processors are further configured to:
transmit a radio resource control (RRC) message indicating the quantity of codewords.

18. The apparatus of claim 15, wherein the quantity of bits is further based on a quantity of CBGs per transport block (TB).

19. The apparatus of claim 15, wherein the one or more processors are further configured to:
transmit a radio resource control (RRC) message indicating a quantity of CBGs across codewords,
wherein the quantity of bits is further based on the quantity of CBGs across codewords.

20. The apparatus of claim 15, wherein the DCI indicates the quantity of codewords.

21. The apparatus of claim 20, wherein the quantity of codewords is equal to 1 based at least in part on one or more of:
a modulation and coding scheme (MCS) field of the DCI being equal to 26, and a redundancy version (RV) field of the DCI being equal to 1;
a quantity of layers indicated in the DCI being equal to 1; or
the quantity of layers indicated in the DCI being less than or equal to 4.

22. The apparatus of claim 15, wherein one or more CBGs are received that correspond to bits in the CBGTI field sequentially from most significant bit to least significant bit.

23. The apparatus of claim 15, wherein one or more CBGs are received that are associated with a first transport block (TB) and a second TB, the one or more CBGs are mapped to the first TB using a first set of bits in the CBGTI field sequentially starting at a most significant bit, and the one or more CBGs are mapped to the second TB using a second set of bits in the CBGTI field sequentially ending at a least significant bit.

24. The apparatus of claim 15, wherein one or more CBGs are received that are associated with a first transport block (TB) and a second TB, the one or more CBGs are mapped to the first TB using a first half of the bits in the CBGTI field sequentially starting at a most significant bit, and the one or more CBGs are mapped to the second TB using a second half of the bits in the CBGTI field sequentially ending at a least significant bit.

25. An apparatus for wireless communication at a user equipment (UE), comprising:
a memory; and
one or more processors, coupled to the memory, configured to:
receive a control message indicating two codewords transmission are enabled;
receive downlink control information (DCI) that schedules a plurality of physical uplink shared channels (PUSCHs), wherein the DCI indicates a first modulation and coding scheme (MCS) for a first codeword of the plurality of PUSCHs and a second MCS for a second codeword of the plurality of PUSCHs; and
transmit on the plurality of PUSCHs according to the DCI.

26. The apparatus of claim 25, wherein the DCI includes a first plurality of new data indicators (NDIs) corresponding to the first codeword of the plurality of PUSCHs and a second plurality of NDIs corresponding to the second codeword of the plurality of PUSCHs.

27. The apparatus of claim 25, wherein the DCI includes a first plurality of redundancy version (RV) indications corresponding to the first codeword of the plurality of PUSCHs and a second plurality of RV indications corresponding to the second codeword of the plurality of PUSCHs.

28. An apparatus for wireless communication at a network entity, comprising:
a memory; and
one or more processors, coupled to the memory, configured to:
transmit a control message indicating two codewords transmission are enabled for a user equipment (UE);
transmit downlink control information (DCI) that schedules a plurality of physical uplink shared channels (PUSCHs), wherein the DCI indicates a first modulation and coding scheme (MCS) for a first codeword of the plurality of PUSCHs and a second MCS for a second codeword of the plurality of PUSCHs; and
receive on the plurality of PUSCHs according to the DCI.

29. The apparatus of claim 28, wherein the DCI includes a first plurality of new data indicators (NDIs) corresponding to the first codeword of the plurality of PUSCHs and a second plurality of NDIs corresponding to the second codeword of the plurality of PUSCHs.

30. The apparatus of claim 28, wherein the DCI includes a first plurality of redundancy version (RV) indications corresponding to the first codeword of the plurality of PUSCHs and a second plurality of RV indications corresponding to the second codeword of the plurality of PUSCHs.
